(19) United States
(12) Patent Application Publication
(10) Pub. No.: US 2017/0069318 A1
(43) Pub. Date: Mar. 9, 2017

(54) Pillow remote controller using audible commands

(71) Applicant: Raymond Henry Hardman, Buena Park, CA (US)

(72) Inventor: Raymond Henry Hardman, Buena Park, CA (US)

(21) Appl. No.: 14/757,237

(22) Filed: Dec. 10, 2015

Related U.S. Application Data
(60) Provisional application No. 62/124,187, filed on Dec. 12, 2014.

(51) Int. Cl. G10L 15/22; A47G 9/10; H04L 29/08

(52) U.S. Cl. CPC G10L 15/22; H04L 67/12; A47G 9/1045; G10L 2015/223; G08C 17/02

(57) ABSTRACT

A pillow, with its internally contained electronics (an audio receiver, decoder, function controller, power controller, transmitter selector, interface, and transmitter circuitries) that provides a user with the ability to conveniently speak, or sound out in any manner, audible commands into it (the pillow) to remotely control the operating functions of various different types of devices while he or she is comfortably resting on it (the pillow)

### BACKGROUND

Many products today operate and are controlled by a cordless remote controlling device. Some of these products include: the television, air conditioning units, adjustable beds, and other devices. Many of these remote controlling devices are of the handheld keypad type.

### PRIOR ART

1. An internet search revealed the availability of voice activated remote controllers only of the hand held type.
2. An internet search revealed the availability of pillow remote controllers only of the finger touch key pad type.

[symbol] appropriate command to its output, which is associated with the audible coded command signal given by the user.

A transmitter selector and interface circuitry also housed within said enclosure which receives commands from the audio receiver, decoder and function command circuitry and selects the appropriate transmitter (particularly important when multiple transmitters are used) then sends the correct function command to the selected transmitter's input.

A transmitter circuitry (one or more) also housed in said enclosure of the pillow, having its (or their) function controlling inputs receiving the function commands from the output of said transmitter selector and interface circuitry and in turn, transmits out a modulated controlling signal that travels to an operating device that is to be controlled. Since there are numerous amounts of different types of transmitter controller devices of equipment and by many different manufacturers, most of which, it is believed, that they have their own individual operating specifications. It is only practical to incorporate the OEM transmitter controller (of a particular manufacturer for their intended piece of equipment to be controlled) as the transmitter circuitry for this invention.

### BRIEF SUMMARY

My invention relates to an apparatus for remote controlling various different types of products and devices using audible commands given by a user for function controlling. This invention provides the advantages over prior art of:
1. Being able to provide comfort for a user resting on a pillow and at the same time provide him or her with the ability to conveniently remotely control the operating functions of various different types of devices and equipment by conveniently sounding out audible commands into the pillow.
2. Being able to provide a remote controlling apparatus incorporated in a pillow that responds to audible commands to send out transmit signals for the device and equipment function controlling.

### DESCRIPTION OF INVENTION

This invention relates to an apparatus comprised of a pillow with its internal contents, having means of receiving an audible acoustical signal (a function coded signal) from a user while he or she is resting on said pillow, decoding its function command and controlling a pillow enclosed transmitter (the RF transmitters should have a verified very low transmit output even if the output has to be reduced and should be as low as possible without compromising operational integrity). The transmitter being controlled will, in turn send (transmit) out a particular modulated signal (the particular signal modulation is associated with the particular audible command given by user) which travels to the receiver of an operating device or equipment for its selected function operation. Each individual audible command from the user would be unique and associated with a given operating function of the intended device that is to be controlled. these individual audible commands may be generated in the normal speaking manner or by humming, whispering, whistling, or any other manner. Additionally, regardless of what manner in which the commands are sounded out, the commands may be represented from any number of audible command coding schemes. One such audible command coding scheme is the “count and hold for function control” scheme. This scheme can provide linear function controlling of operating devices and equipment which duplicate the action of, causing a devices' function to operate for the period of time in which an operator keeps a particular switch or key on a keypad held down (or depressed). This coded scheme operates as follows: a given number of quick sounds would be produced (counting the numerals or other type words can be used if desired) initially. Each count amount (number of quick sounds) represent a specific operating function of the intended device that is to be controlled. Then, after a brief pause, a sustained sound would be produced for the same length of time required to have a desired function in action.

### EXAMPLE

| Function Select | | | Activation Time |
|---|---|---|---|
| Code | Initial Count | Pause | (Sustained Sound) |
| Move left | 1 * 2 * 3 * 4 | | P-L-E-A-S-E |
| Move right | 1 * 2 * 3 * 4 * 5 | | P-L-E-A-S-E |
| Move up | 1 * 2 | | P-L-e-a-s-e |
| Move down | 1 * 2 * 3 | | P-l-e-a-s-e |
| Any function | Pa Pa Pa Pa Pa Pa | | 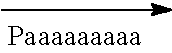 |

A given code also may be able to activate two or more functions simultaneously. An appropriate sound or word should be used that will produce an immediate noise (quick rise time) then a sudden silence (quick fall time) Example: word beginning with the letters “B”, “P”, or “M” may be used. The letter “P” may be the best. With these letters the lips are closed at the beginning of the word and then a burst of sound after the lips are open. In some cases, there may be a time delay before the beginning of a function activation associate with someone operating equipment. This invention may be used in various different function controlling applications such as: the television, the air conditioning unit, doors, windows, curtains, blinds, adjustable chairs, adjustable beds, and other devices. The adjustable bed application, each adjustable function (move head section up, move head section down, move leg/feet section up, start/increase massage, et cetera) would be controlled by a specific word or set of words or by a uniquely coded audible command. In the adjustable bed application using the “count and hold for function control” coding scheme, one would simply count out (or produce the number of sounds) the number necessary to select a particular function (maybe a count of these for head section moving up) then briefly paused. Afterward, produce a follow up sustained sound for the duration of time that is desired for that head section to be moving in an upward direction. This invention may employ various different enhancements. Example:
1. Time out alarm and/or disable feature which would create an alarm and/or disable/power off some of the circuitry within the pillow after a certain time duration, starting from the time that circuitry was enabled/powered up. This would be to make the system within the pillow completely disabled.
2. An audible and/or some other type of alarm such as a vibrating or visual that can be activated for a short period of time. Each time, enabling pressure sensor is activated. This pressure sensor activation initiated the system's powering up/enabling process. With this feature, the system with the pillow can be delayed from being active until a short period of time after the end of this timeout period, the alarm would go off just prior to the system becoming active.

### BEST MODE FOR CARRYING OUT THE INVENTION

FIG. 1 shows the pillow's lengthwise edge view outline 1, with cross sectional view of its internal contents, which includes an enclosure 2, which is to house the electronica. The pressure sensors 3 and 4, which activate the electronics upon sensing pressure when one is resting on pillow. A flexible hollow tube 5, linking an opening in the enclosure to a screen termination at some surface location of pillow to channel the audible commands into the enclosure from the user and also to channel any audible alarms that would be generated within the enclosure to the user, outside of pillow. There is a cable link 6, from the enclosure to an infrared LED 7, near the edge of the pillow. This cable and infrared LED may possibly be replaced with fiber optics. It receives the output from an IR transmitter within the enclosure and transmit an infrared signal to a distant device, such a television et cetera. The box looking connector 8, with its upper and lower attached cables. plugs into its mating jack of the enclosure. These two cables with their human sensing element at their ends and at or near surfaces of pillow represent an arrangement of the sending unit portion of an infrared type human presence sensing circuitry. These two cables are to send signals to the power control and alarm circuitry which is house in the enclosure. The human sensing portion of this power control and alarm circuitry which inhibit the powering up/enabling of the other two circuitries that the power control and alarm circuitry controls if no one is present. This feature provides further assurance of the pillow controller not functioning if no one is around.

### DESCRIPTION OF DRAWINGS

FIG. 1 Overall Diagram of Pillow showing its lengthwise edge view, with internal contents

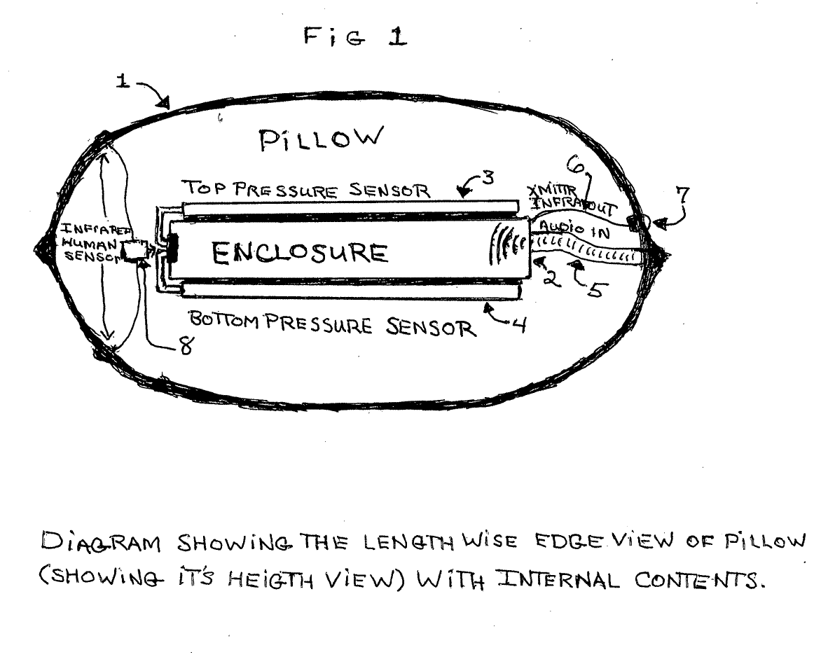

FIG. 2 Diagram of Pillow from top view, showing internal contents

FIG. 3 Schematic diagram of the audio receiving decoding and function command circuitry that employs the “Count and hold for function control” technique for equipment function controlling.

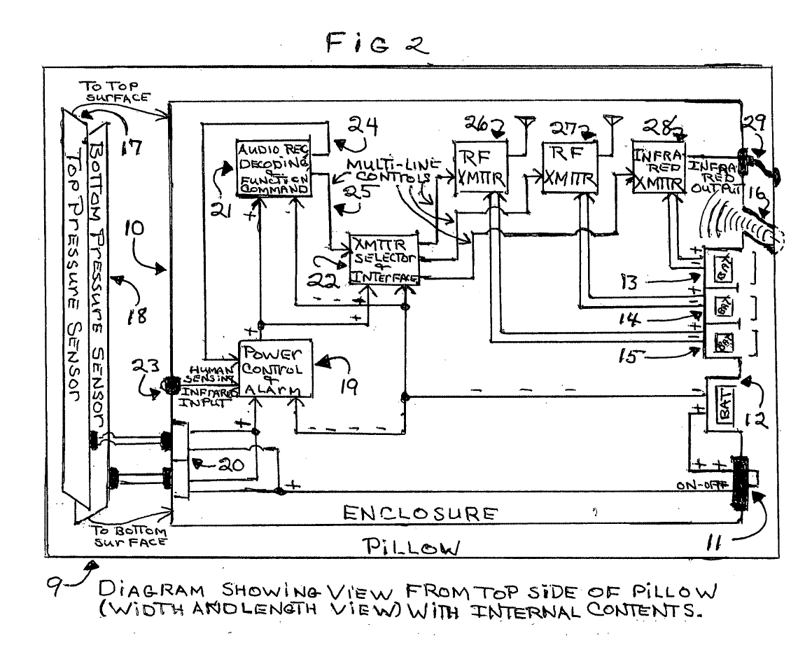

FIG. 2 shows the top view outline 9, of pillow with cross sectional view of its internal contents which consists of an enclosure 10, (should be of firm plastic composition) to house the electronics. This enclosure should be as flat (low height) as possible, but of sizeable width and length relative to the size of the pillow. The enclosure may have an on-off switch 11, mounted to its surface. The enclosure may have a compartment 12, that retains the battery that powers all of the circuitries, (with exception of the transmitter circuitries) within the enclosure and compartments 13, 14, 15, that retain batteries that power the transmitter circuitries. The somewhat flexible, hollow tube 16, is for channeling the audio command signal from outside of pillow to interior of enclosure and within the enclosure to the exterior of the pillow. The top pressure sensor 17, and the bottom pressure sensor 18, may be relatively flat and each should cover a good portion of the width and length of the enclosure and be physically attached to the top and bottom side of the enclosure, respectively. Within the enclosure there may be a number of individual separately functioning circuitries and may interact with each other. Also, most or all of these individual circuitries may be incorporated onto one printed circuit board. In FIG. 2, the power control and alarm circuitry 19, receives the battery output via on-off switch 11, and top pressure sensor 17, and or bottom pressure sensor 18, (when on-off switch is on and someone is resting on pillow) through jack connection 20. The purpose of this circuitry 19, is to distribute the battery power to the audio receiving, decoding and function command circuitry 21, and the transmitter selection and interface circuitry 22, under certain conditions, such as:
1. There having to be someone resting on the pillow and that only up to a certain period of time starting from the time the one starts the resting on the pillow. This time period will continue to be extended as long as there is input audio command activity. The audio command activity output line 24, from circuitry 21, controls this delay extension.
2. There having to be sensed someone's presence nearby, which is done by infrared sensing within the circuitry which uses the output from an infrared human sensing sending until 23.

In FIG. 2, the audio receiving, decoding and function command circuitry 21, receives the audible command signal, selects the appropriate line of its multiline output 25, this multiline feeds into the transmitter selector and interface circuitry 22, when multiple transmitters are used, the transmitter selector and interface circuitry 22, will first select the appropriate transmitter as per the transmitter selecting segment of a multisegment audible command (properly interfaced), to the selected transmitter. The transmitter circuitries 26 and 27 are of the RF type and when selected, receives the appropriate function control and transmits out a modulated signal accordingly, which signal travels to an intended device for the operation of its functions. In FIG. 2, the infrared transmitter 28, when selected, receives the function command then transmits out its modulated signal to an infrared LED at the pillow's surface VIA flexible cable 29, for infrared transmission to an remote device such as a television, air conditioning unit, or other type equipment.

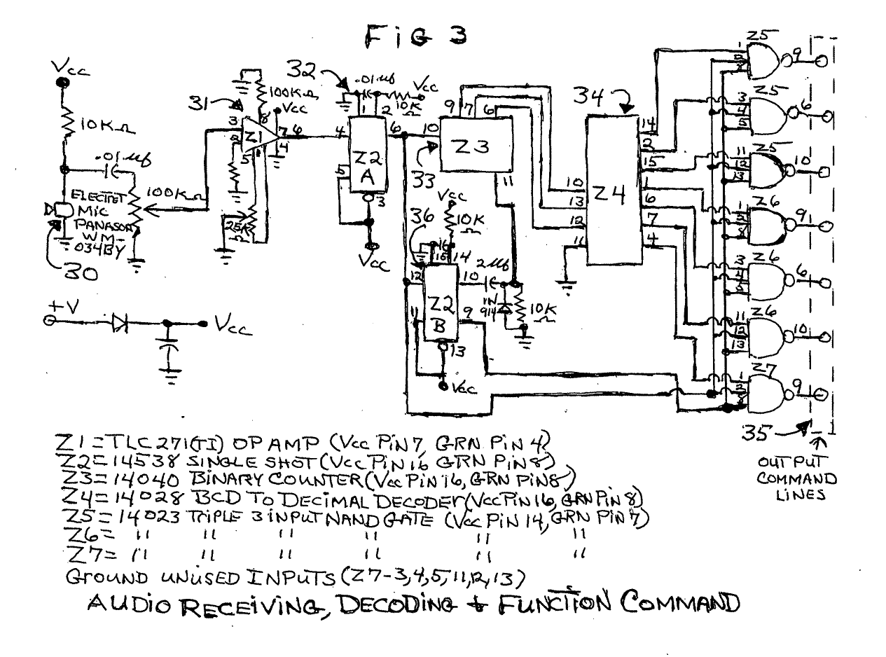

FIG. 3 is the schematic diagram of the audio receiving, decoding and function command circuitry which identified as circuitry 21, in FIG. 2. This circuit arrangement uses the “count and hold for function control” function coding scheme. It operates as follows: The audible commands signal gets received by the microphone 30, with its associated components then goes in and gets boosted up by the amplifier circuit of Z1 31, now this amplified signal go to Z2-A's timing circuit 32, which is a monostable multivibrator with timing just enough to create a constant high at its pin 6 output when a continuous input audio signal is received and its output will go low when that audio signal has gone away. Since each simple word or syllable creates a continuous sound for its duration, one positive level pulse at this output will be generated for the length of time of each syllable or single syllable word. Therefore, the given number of simple words or syllables will cause the same number of positive level pulses to be generated at this output which gets fed into Z3's pulse counter circuit 33. This pulse counter circuit 33,'s binary output feeds into the Z4 decoder circuit 34, which selects one of it's output (making it go high) depending on, in effect the number of simple words or syllables that are spoken. Each of the decoders' output goes to a particular triple input nand gate. Each nand gate's output goes to the composite output command lines 35. Z2-B's timing circuit 36, has a longer timeout period. Its output at pin 10, when the first in a series of pulses from Z2-A pin 6's output occur, the positive going edge of that first pulse causes Z2-B pin 10's output to go high. Which in turn, feeds into a differentiating network which causes a positive voltage pulse at its output. Then it feeds that positive pulse to the reset input to the pulse counter causing the counter to reset to zero before it starts counting a series of pulses; hence, a series of syllables spoken. The remainder of the pulses in that series keeps Z2-B pin 10's output high and no further positive reset pulse for the counter occurs for the duration of that series of pulses. This stays high for that duration because it has a long timeout period. The Z3 pulse counter gets triggered (increments) on the negative going edge of the pulses. Therefore, the positive going edge of the “first pulse only” in a series of pulses initially resets the counter. Then comes the falling or negative going edges of the remainder of the pulse in that series causes the counter to increment (count up) to a value equal to the number of pulses (or syllables) in that series. The nand gates input from Z2-B pin 9 insures the function selection is only made after all of the pulses (syllables) in a series are in and the counting is completed. The nand gates input from Z2-A pin 6 causes the selected output for a function to occur for the duration and only that duration of time of the follow up sustained sound which comes at the end of the pause that follows audible counting. The nand gate outputs provide the sinking technique for controlling inputs of other circuitry.

1. Pillow Remote Controller Apparatus Comprising:
A Pillow, along with its internally contained parts and equipment, having means of providing the ability of someone to rest on said pillow and also at the same time, if desired, remotely control the operating functions of any number of different devices and equipment by speaking (or sound-out) special audible commands into said pillow. Some of these said devices and equipment include:
1. Adjustable beds
2. Adjustable lift+other chairs
3. Air conditioning units
4. Televisions/radios
5. Window blinds and curtains
6. Other entertainment equipment
7. Telephone equipment
Also, internally contained within said pillow and most likely in an enclosure within, may be an audio generating device, such as a radio, player; which would be controlled by audible means from a user resting on said pillow as stated above. With this radio or other audio generating device, its moderate audio output level may travel to the exterior of the said pillow through the same passage way that channels the audible command from said user outside the pillow to the interior of said enclosure. Also with said pillow and most likely within its said enclosure may be a Bluetooth transmitter and/or receiver that would be controlled by audible means by a user in a similar fashion as stated above. This Bluetooth device contained within said pillow can be for telephone/cellular communications or other purposes.

2. A Pillow Remote Controller Apparatus as in claim 1 Comprising:
A pillow having a passageway (recommended at end of pillow) for an enclosure with its associated parts, to be inserted into or removed from its interior. Also said pillow having means of storing said enclosure in its interior. Said pillow also having one or more designated areas at its outer surface for receiving an audible acoustical signal and means of channeling said audible signal into said enclosure, internally contained in said pillow. The pillow also having means of passing any internal transmitter generated control signal to its exterior that would enable said signal to travel to a distant receiver for equipment function controlling. The pillow may also have an infrared Light Emitting Diode element near or at its outer surface for ejection of said signal.
An enclosure to be contained within said pillow that houses the electronic equipment necessary for the device and equipment controlling operation as described in claim one. Also said enclosure may have one or more battery compartments to contain batteries necessary to power the circuitry within the enclosure.
A pressure sensing element (with one arrangement, two sensing elements) physically attached to said enclosure of the pillow that will be active upon the sensing of someone resting on said pillow and in doing so will imitate the powering up and enabling of the of audible command reception from the user.
A power distribution point such as the power control and alarm circuitry housed within said enclosure, after having received battery power from pressure sensors will, depending specified conditions, in cases where the power control and alarm circuit is used, distribute the battery power to other circuits such as an audio receiving, decoding and function command circuitry, also possibly a transmitter selector and interface circuitry.
An audio receiving, decoding, and function command circuitry also housed within said enclosure of said pillow which receives, decodes (interprets) the audible commands given by a user and applies the [symbol]
